(19) United States
(12) Patent Application Publication
(10) Pub. No.: US 2018/0007118 A1
(43) Pub. Date: Jan. 4, 2018

(54) REAL-TIME APPLICATION BEHAVIOR CHANGES

(71) Applicant: Microsoft Technology Licensing, LLC, Redmond, WA (US)

(72) Inventors: Hani Loza, Kirkland, WA (US); Jonathan Keslin, Kirkland, WA (US)

(21) Appl. No.: 15/199,359

(22) Filed: Jun. 30, 2016

(51) Int. Cl. H04L 29/08; H04L 29/06; H04L 12/26

(52) U.S. Cl. CPC H04L 67/025; H04L 43/08; H04L 67/42

(57) ABSTRACT

Aspects of the present disclosure relate to systems and methods for adjusting a behavior of an application in real-time. Telemetry for a client computing device, a server computing device, and a network associated with the application may be received. It may be determined, while the application is running in real-time, whether to adjust the behavior of the application using the received telemetry. In response to determining to adjust the behavior of the application, the behavior of the application may be adjusted based on the received telemetry while the application is running in real-time.

### BACKGROUND

Web applications are becoming increasingly complex. For example, web applications may run logic on a server and a client (e.g., web browser) and exchange data in between via a network. The performance characteristics of the client, server, and network are dynamic and may each vary independently. Generally, web applications are optimized according to average performance characteristics. In this regard, current web application efficacy is limited in above average and/or below average contexts. Furthermore, current web applications may be optimized by making a code change within the web application and releasing a new and/or updated product version with the changes. Additionally, web applications may be optimized by focusing on performance characteristics/data of only a single entity (e.g., the client or the server or the network). In turn, current techniques for optimizing web applications are inefficient and inadequate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for adjusting a behavior of an application in real-time. Telemetry for a client computing device, a server computing device, and a network associated with the application may be received. It may be determined, while the application is running in real-time, whether to adjust the behavior of the application using the received telemetry. In response to determining to adjust the behavior of the application, the behavior of the application may be adjusted based on the received telemetry while the application is running in real-time.

In another aspect, a method for optimizing an application in real-time using telemetry is presented. The method may include collecting telemetry for a client computing device, a server computing device, and a network associated with a web application. The method may further include measuring a plurality of performance characteristics of the client computing device, the server computing device, and the network by processing the telemetry. The method may further include determining, while the application is running in real-time, whether to adjust a behavior of the web application based on the plurality of performance characteristics. The method may further include in response to determining to adjust the behavior of the application, changing, while the web application is running in real-time, one or more web application characteristics based on the plurality of performance characteristics.

In further aspects, telemetry for at least one of a client computing device, a server computing device, and a network associated with the application may be received. A plurality of performance characteristics of at least one of the client computing device, server computing device, and network may be measured by processing the telemetry. When at least one performance characteristic of the plurality of performance characteristics does not meet a performance level, at least one application characteristic may be adjusted while the application is running in real-time.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an exemplary optimized application behavior system implemented at a client computing device for optimizing an application in real-time using telemetry, according to an example aspect.

FIG. 2 illustrates an exemplary optimized application behavior system implemented at a server computing device for optimizing an application in real-time using telemetry, according to an example aspect.

FIG. 3 illustrates an exemplary method for adjusting a behavior of an application in real-time, according to an example aspect.

FIG. 4 illustrates an exemplary method for optimizing an application in real-time using telemetry, according to an example aspect.

FIG. 5 illustrates an exemplary method for optimizing an application in real-time using telemetry, according to an example aspect.

FIG. 6 illustrates a computing system suitable for implementing the enhanced application optimization technology disclosed herein, including any of the environments, architectures, elements, processes, user interfaces, and operational scenarios and sequences illustrated in the Figures and discussed below in the Technical Disclosure.

### DETAILED DESCRIPTION

Aspects of the disclosure are generally directed to optimizing an application in real-time using telemetry. For example, the behavior of the application may be adjusted in real-time based on collected telemetry such that the application is performing at an optimal level. In one aspect, while the application is running, e.g., after the application is launched and a user is actively engaged with the application, the application may collect telemetry associated with the devices on which the application is running For example, the application may collect telemetry associated with a client device, a server device, and a network connection between the client device and the server device. In one example, the telemetry may be used to measure a plurality of performance characteristics of the client device, server device, and the network connection between the client device and the server device. For example, the application may send a request from the client to the server. The telemetry collected may include the time from when the request was sent from the client to when the request is received at the server. In this example, a performance characteristic of the network (e.g., the speed of the network) may be measured. In some cases, while the application is still running (e.g., for the given user session), the application behavior may be adjusted to optimize performance given the context (e.g., based on the performance characteristics of the client device, the server device, and the network). In this example, if the measured network speed indicates a slow network pipe, the application may be adjusted at the client to batch network requests, for example. In another example, the application may be adjusted at the client to request fewer resources at the server. In yet another example, the application may be adjusted at the client to request different resources at the server.

As discussed above, web applications are optimized according to average performance characteristics. In this regard, current web application efficacy is limited in above average and/or below average contexts. Furthermore, current web applications may be optimized by making a code change within the web application and releasing a new and/or updated product version with the changes. Additionally, web applications may be optimized by focusing on performance characteristics/data of only a single entity (e.g., the client or the server or the network). In turn, current techniques for optimizing web applications are inefficient and inadequate. Accordingly, aspects described herein include optimizing an application in real-time using telemetry. In one aspect, telemetry may be collected for at least a client, a server, and a network associated with the application. In one example, the application is a web application. In this regard, the application may run on the client and the server and exchange data in between via the network.

In some examples, while the application is running in real-time, it may be determined whether to adjust the behavior of the application using the collected telemetry. For example, the collected telemetry may provide information regarding performance characteristics of the client, the server and the network. The performance characteristics may include network speed, script execution, server code execution, network bandwidth, and the like. In this regard, the behavior of the application may be adjusted based on the performance characteristics. For example, the script execution may indicate the client device is running slow, the server code execution may indicate the server is running slow, the network speed may indicate the network pipe is slow, and the network bandwidth may indicate a wide or narrow network pipe. As such, it may be determined to adjust the behavior of the application based on the collected telemetry and/or performance characteristics. One or more characteristics of the application may be adjusted depending on the context. Additionally, a plurality of performance characteristics of the client, the server, and the network may be used to determine whether to and/or how to adjust the behavior of the application such that the application is optimized while running in real-time for a given user session (e.g., for the given context). In this regard, a technical effect that may be appreciated is that optimizing an application in real-time, for a given user session, using telemetry facilitates a compelling visual and functional experience to allow users to efficiently view and interact with a user interface to quickly, easily, and efficiently view and interact with content associated with the application. Another technical effect that may be appreciated is that by adjusting the behavior of the application in real-time, processor load may be reduced, memory may be conserved, and network bandwidth usage may be reduced.

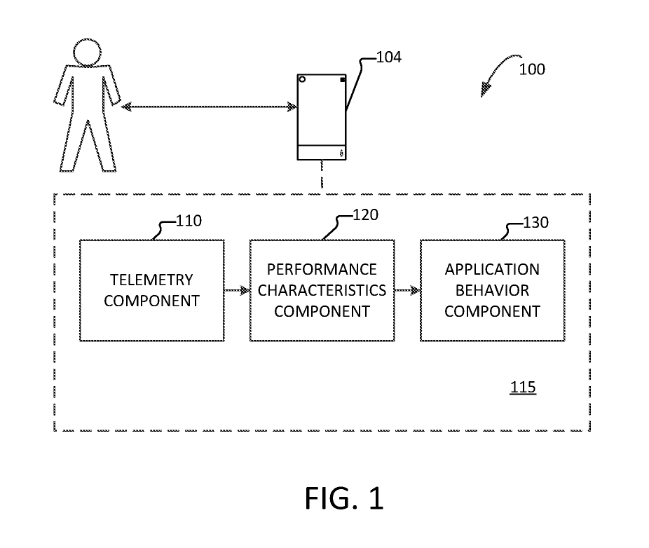

Referring now to the drawings, in which like numerals represent like elements through the several figures, aspects of the present disclosure and the exemplary operating environment will be described. With reference to FIG. 1, one aspect of an application optimization system 100 for optimizing an application in real-time using telemetry is illustrated. In aspects, the application optimization system 100 may be implemented on a client computing device 104. In a basic configuration, the client computing device 104 is a handheld computer having both input elements and output elements. The client computing device 104 may be any suitable computing device for implementing the application optimization system 100 for optimizing an application in real-time using telemetry. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for the application optimization system 100 for optimizing an application in real-time using telemetry may be utilized

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As illustrated in FIG. 1, the client computing device 104 may include an application 115, a telemetry component 110, a performance characteristics component 120, and an application behavior component 130. The various components may be implemented using hardware, software, or a combination of hardware and software. In examples, a user interface component of the client computing device 104 may initiate rendering of the application 115 in a user interface of the client computing device 104 (not illustrated). In some examples, the application 115 is a web application. The web application may include any client-server software application where the client (e.g., user interface) runs in a web browser. In some examples, the application 115 includes the telemetry component 110, the performance characteristics component 120, and the application behavior component 130. In some examples, the application 115 may include one or more of, or any combination of the telemetry component 110, the performance characteristics component 120, and the application behavior component 130.

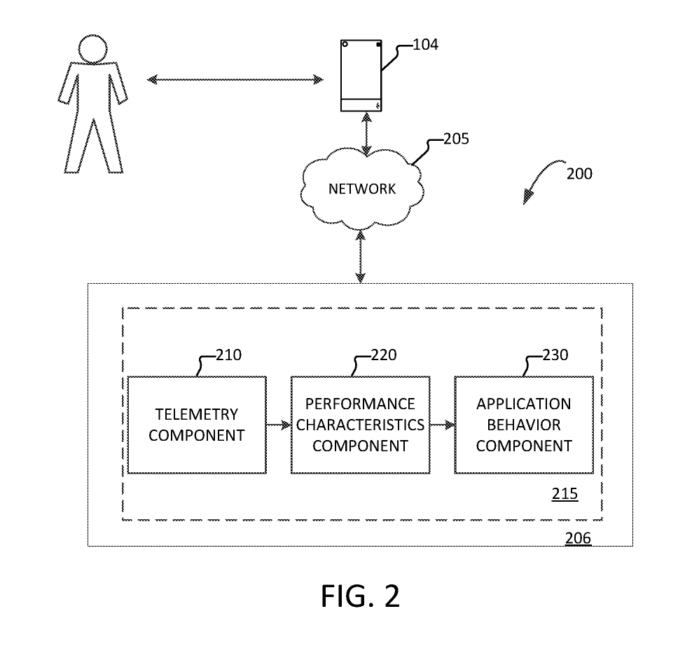

In one example, the telemetry component 110 may be configured to collect telemetry for the client computing device 104. In one example, the telemetry may include data that may be used for measuring performance characteristics of the client computing device 104. In some cases, the telemetry component 110 may be part of the application 115 that is rendered in the user interface of the client computing device 104. In this regard, the application 115 may collect and/or receive telemetry for the client computing device 104. In some cases, the telemetry component 110 may collect and/or receive telemetry for a server computing device and/or a network connecting the client computing device 104 and the server computing device (which will be illustrated relative to FIG. 2). For example, the client computing device 104 and/or the telemetry component 110 may receive telemetry from the server computing device via the network connecting the client computing device 104 and the server computing device. In one example, the telemetry received from the server computing device may indicate that the server computing device is responding slowly to requests for resources and/or data from the client computing device 104.

As discussed above, the telemetry may include data that may be used for measuring performance characteristics of the client computing device 104. For example, the telemetry may include an amount of time that it takes for a client operation to be executed. In some examples, the telemetry may include an amount of time that it takes for a plurality of client operations to be executed. In other examples, the telemetry may include an amount of time between when a client request is sent to and received at a server computing device. In other examples, the telemetry may include an amount of time between when a server computing device receives a client request and when the server computing device sends a reply to the client request. In other examples, the telemetry may include an amount of time between when a server reply is sent to and received at the client computing device 104. In other examples, the telemetry may include an amount of time for downloading files of various sizes. In this regard, the performance characteristics component 120 may be configured to determine, while the application 115 is running in real-time, whether to adjust the behavior of the application 115 using the collected and/or received telemetry. In some cases, the performance characteristics component 120 may determine whether to adjust the behavior of the application 115 by processing the collected and/or received telemetry to measure a plurality of performance characteristics of the client computing device 104 and/or a network. In one example, the plurality of performance characteristics may include script execution performance, network speed, and network bandwidth. For example, when the telemetry includes an amount of time that it takes for a plurality of client operations to be executed, the script execution performance at the client computing device 104 may be measured by the performance characteristics component 120. In another example, when the telemetry includes an amount of time between when a server reply is sent to and received at the client computing device 104, the network speed may be measured by the performance characteristics component 120. In other examples, when the telemetry includes an amount of time for downloading files of various sizes, the network bandwidth may be measured by the performance characteristics component 120.

In aspects, the application behavior component 130 may be configured to adjust, while the application 115 is running in real-time, the behavior of the application 115 based on the collected and/or received telemetry. In this regard, in response to determining to adjust the behavior of the application, the application behavior component 130 may adjust the behavior of the application based on the collected and/or received telemetry while the application 115 is running in real-time. In some examples, the behavior of the application 115 may be adjusted for a given user session. For example, a given user session may start when a user launches the application 115 and end when the user closes the application 115. In another example, a given user session may begin when a user logs-in to the application 115 and end when the user signs out of the application 115.

In some examples, adjusting the behavior of the application 115 based on the received and/or collected telemetry while the application 115 is running in real-time may include changing at least one characteristic of the application 115 (e.g., application characteristic). An application characteristic may include any feature and/or function of the application 115 such as a number of requests sent, how requests are sent, resolution of content (e.g., pictures, audio, video), API calls, server connections, operations, and the like. In other examples, adjusting the behavior of the application 115 based on the received and/or collected telemetry while the application 115 is running in real-time may include changing a plurality of application characteristics. In this regard, any number of the application characteristics described herein may be adjusted and/or changed while the application 115 is running in real-time and for a given user session.

In aspects, changing at least one characteristic of the application 115 and/or a plurality of characteristics of the application 115 may include at least one of batching network requests, using low resolution files, using high resolution files, using image sprites, using at least one alternate server API (Application Programming Interface), connecting to an alternate server, requesting resources from a plurality of servers, and limiting client operations. For example, in one scenario, when a slow network pipe is measured, the application behavior component 130 may batch network requests. In another example, when a slow network pipe is measured, the application behavior component 130 may send requests for different resources. In another scenario, when server code execution is measured as running slow, the application behavior component 130 may call alternate server APIs (e.g., to decrease the load on the server). In another scenario, when server code execution is measured as running slow, the application behavior component 130 may connect to a different server. In another scenario, when server code execution is measured as running slow and/or a high bandwidth network is measured, the application behavior component 130 may request resources from a plurality of servers at the same time. In another scenario, when script execution is measured as running slow, the application behavior component 130 may limit low-priority client operations. It is appreciated that while specific examples of adjusting and/or changing a plurality of application characteristics based on performance characteristics and/or collected/received telemetry are discussed, the specific examples discussed should not be considered as limiting. Any suitable number of application characteristics may be changed and/or adjusted in real-time based on the collected and/or received telemetry and/or the performance characteristics discussed herein.

FIG. 2 illustrates one aspect of an application optimization system 200 for optimizing an application in real-time using telemetry. In aspects, the application optimization system 200 may be implemented on a server computing device 206. The server computing device 206 may provide data to and from the client computing device 104 through a network 205. In aspects, the application optimization system 200 may be implemented on more than one server computing device 206, such as a plurality of server computing devices 206. In one example, the server computing device 206 includes a cloud service. In another example, the server computing device 206 includes an application service. The data may be communicated over any network suitable to transmit data. In some aspects, the network 205 is a distributed computer network such as the Internet. In this regard, the network 205 may include a Local Area Network (LAN), a Wide Area Network (WAN), the Internet, wireless and wired transmission mediums. In some aspects, the application optimization system 200 may be implemented on both a client computing device 104 and a server computing device 206.

As illustrated in FIG. 2, the server computing device 206 may include an application 215, a telemetry component 210, a performance characteristics component 220, and an application behavior component 230. The various components may be implemented using hardware, software, or a combination of hardware and software. In examples, a user interface component of the client computing device 104 may initiate rendering of the application 215 in a user interface of the client computing device 104 (not illustrated). In some examples, the application 215 is a web application. The web application may include any client-server software application where the client (e.g., user interface) runs in a web browser. In some examples, the application 215 includes the telemetry component 210, the performance characteristics component 220, and the application behavior component 230. In some examples, the application 215 may include one or more of, or any combination of the telemetry component 210, the performance characteristics component 220, and the application behavior component 230.

In one example, the telemetry component 210 may be configured to collect telemetry for the server computing device 206. In one example, the telemetry may include data that may be used for measuring performance characteristics of the server computing device 206. In some cases, the telemetry component 210 may be part of the application 215. In this regard, the application 215 may collect and/or receive telemetry for the server computing device 206. In some cases, the telemetry component 210 may collect and/or receive telemetry for the client computing device 104 and/or the network 205 connecting the client computing device 104 and the server computing device 206. For example, the server computing device 206 and/or the telemetry component 210 may receive telemetry from the client computing device 104 via the network 205 connecting the client computing device 104 and the server computing device 206. In one example, the telemetry received from the client computing device 104 may indicate that the client computing device 104 is on a slow machine (e.g., running slow).

As discussed above, the telemetry may include data that may be used for measuring performance characteristics of the server computing device 206. For example, the telemetry may include an amount of time that it takes for a server operation to be executed. In some examples, the telemetry may include an amount of time that it takes for a plurality of server operations to be executed. In other examples, the telemetry may include an amount of time between when a client request is sent to and received at the server computing device 206. In other examples, the telemetry may include an amount of time between when the server computing device 206 receives a client request and when the server computing device 206 sends a reply to the client request. In other examples, the telemetry may include an amount of time between when a server computing device 206 reply is sent to and received at the client computing device 104. In other examples, the telemetry may include an amount of time for downloading files of various sizes. In this regard, the performance characteristics component 220 may be configured to determine, while the application 215 is running in real-time, whether to adjust the behavior of the application 215 using the collected and/or received telemetry. In some cases, the performance characteristics component 220 may determine whether to adjust the behavior of the application 215 by processing the collected and/or received telemetry to measure a plurality of performance characteristics of the server computing device 206 and/or the network 205. In one example, the plurality of performance characteristics may include server code execution performance, network speed, and network bandwidth. For example, when the telemetry includes an amount of time between when the server computing device 206 receives a client request and when the server computing device 206 sends a reply to the client request, the server code execution performance at the server computing device 206 may be measured by the performance characteristics component 220. In another example, when the telemetry includes an amount of time between when a client request is sent to and received at the server computing device 206, the network speed may be measured by the performance characteristics component 220. In other examples, when the telemetry includes an amount of time for sending and/or downloading files of various sizes, the network bandwidth may be measured by the performance characteristics component 220.

In aspects, the application behavior component 230 may be configured to adjust, while the application 215 is running in real-time, the behavior of the application 215 based on the collected and/or received telemetry. In this regard, in response to determining to adjust the behavior of the application, the application behavior component 230 may adjust the behavior of the application based on the collected and/or received telemetry while the application 215 is running in real-time. In some examples, the behavior of the application 215 may be adjusted for a given user session. For example, a given user session may start when a user launches the application 215 and end when the user closes the application 215. In another example, a given user session may begin when a user logs-in to the application 215 and end when the user signs out of the application 215.

In some examples, adjusting the behavior of the application 215 based on the received and/or collected telemetry while the application 215 is running in real-time may include changing at least one characteristic of the application 215 (e.g., application characteristic). An application characteristic may include any feature and/or function of the application 215 such as a number of requests sent, how requests are sent, resolution of content (e.g., pictures, audio, video), API calls, server connections, operations, and the like. In other examples, adjusting the behavior of the application 215 based on the received and/or collected telemetry while the application 215 is running in real-time may include changing a plurality of application characteristics. In this regard, any number of the application characteristics described herein may be adjusted and/or changed while the application 215 is running in real-time and for a given user session.

In aspects, changing at least one characteristic of the application 215 and/or a plurality of characteristics of the application 215 may include at least one of batching network requests, using low resolution files, using high resolution files, using image sprites, using at least one alternate server API (Application Programming Interface), connecting to an alternate server, requesting resources from a plurality of servers, and limiting client operations. For example, in one scenario, when a slow network pipe is measured, the application behavior component 230 may batch files for downloading at the client computing device 104. In another scenario, when a narrow (e.g., low bandwidth) network pipe is measured, the application behavior component 230 may adjust the application 215 by using image sprites instead of individual images. In another scenario, when a narrow (e.g., low bandwidth) network pipe is measured, the application behavior component 230 may adjust the application 215 by using low resolution images, audio, or video. In another scenario, when a wide (e.g., high bandwidth) network pipe is measured, the application behavior component 230 may adjust the application 215 by using high resolution images, audio, or video. In another scenario, when script execution is measured as running slow, the application behavior component 230 may adjust the application 215 by sending a file (e.g., JavaScript) to the client computing device 104 that is optimized for a slow machine. It is appreciated that while specific examples of adjusting and/or changing a plurality of application characteristics based on performance characteristics and/or collected/received telemetry are discussed, the specific examples discussed should not be considered as limiting. Any suitable number of application characteristics may be changed and/or adjusted in real-time based on the collected and/or received telemetry and/or the performance characteristics discussed herein.

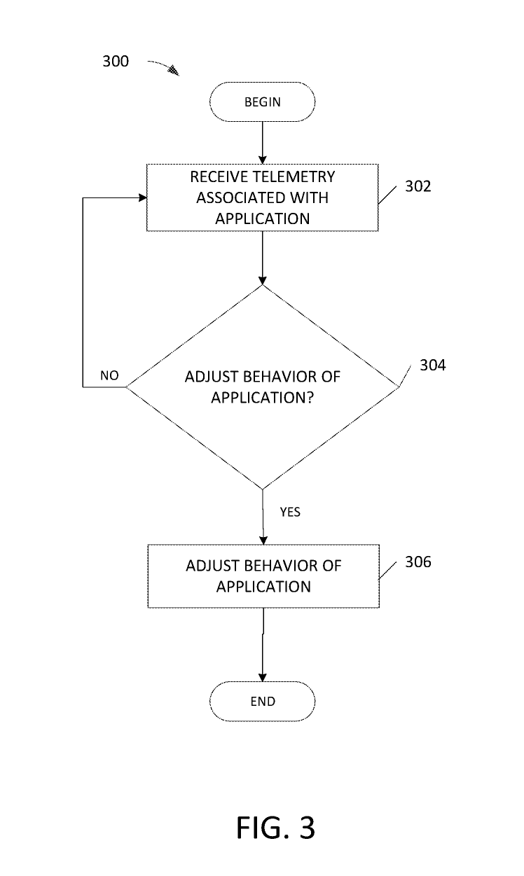

Referring now to FIG. 3, an exemplary method 300 for adjusting a behavior of an application in real-time, according to an example aspect is shown. Method 300 may be implemented on a computing device or a similar electronic device capable of executing instructions through at least one processor. Method 300 may begin at operation 302, where telemetry for a client computing device, a server computing device, and a network associated with an application is received. For example, the received telemetry may provide information regarding performance characteristics of the client computing device, the server computing device and the network. In one example, telemetry for the client computing device is received at a client computing device. In another example, telemetry for the server computing device is received at a server computing device. In another example, telemetry for the network may be received by at least one of a client computing device and a server computing device. In another example, telemetry for the client computing device is received at a server computing device. In another example, telemetry for the server computing device is received at a client computing device.

When telemetry is received for a client computing device, a server computing device, and a network, flow proceeds to decision operation 304 where it is determined, while the application is running in real-time, whether to adjust a behavior of the application using the received telemetry. For example, determining whether to adjust the behavior of the application using the received telemetry may include processing the collected and/or received telemetry to measure a plurality of performance characteristics of the client computing device, the server computing device, and the network. In one example, the plurality of performance characteristics may include script execution performance, network speed, server code execution performance, and network bandwidth. When it is determined not to adjust the behavior of the application using the received telemetry, flow proceeds back to operation 302 where telemetry is received for the client computing device, the server computing device, and the network.

When it is determined to adjust the behavior of the application, flow proceeds to operation 306 where the behavior of the application is adjusted, while the application is running in real-time, based on the received telemetry. In some examples, adjusting the behavior of the application based on the received telemetry while the application is running in real-time may include changing at least one application characteristic. An application characteristic may include any feature and/or function of the application such as a number of requests sent, how requests are sent, resolution of content (e.g., pictures, audio, video), API calls, server connections, operations, and the like. In other examples, adjusting the behavior of the application based on the received telemetry while the application is running in real-time may include changing a plurality of application characteristics. In this regard, any number of the application characteristics described herein may be adjusted and/or changed while the application is running in real-time and for a given user session.

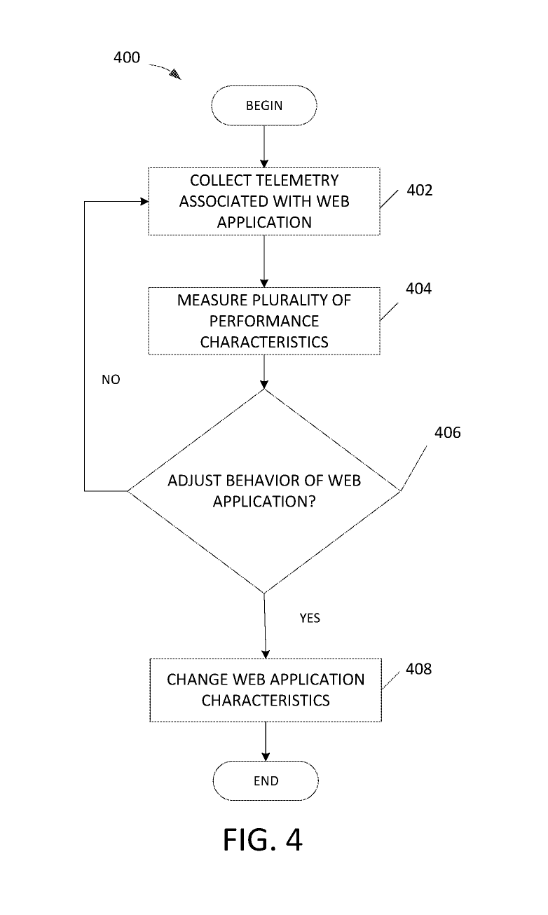

Referring now to FIG. 4, an exemplary method 400 for optimizing an application in real-time using telemetry, according to an example aspect is shown. Method 400 may be implemented on a computing device or a similar electronic device capable of executing instructions through at least one processor. Method 400 begins at operation 402 where telemetry for a client computing device, a server computing device, and a network associated with a web application is collected. For example, the collected telemetry may provide information regarding performance characteristics of the client computing device, the server computing device and the network. In one example, telemetry for the client computing device is collected at a client computing device. In another example, telemetry for the server computing device is collected at a server computing device. In another example, telemetry for the network may be collected by at least one of a client computing device and a server computing device. In another example, telemetry for the client computing device is collected at a server computing device. In another example, telemetry for the server computing device is collected at a client computing device.

When telemetry is collected for a client computing device, a server computing device, and a network, flow proceeds to operation 404 where a plurality of performance characteristics of the client computing device, the server computing device, and the network are measured. In one example, the plurality of performance characteristics of the client computing device, the server computing device, and the network are measured by processing the collected telemetry. In one example, the plurality of performance characteristics may include script execution performance, network speed, server code execution performance, and network bandwidth. The script execution performance may indicate an amount of time it takes for various client computing device operations to be executed. The network speed may indicate an amount of time it takes for client requests and server responses to be communicated over the network. The server code execution performance may indicate an amount of time for the server computing device to process a request (e.g., the amount of time from when the server computing device receives the request and sends a response). The network bandwidth may indicate the performance of file downloads of varying sizes and/or how many files are requested at a given time.

When a plurality of performance characteristics of the client computing device, the server computing device, and the network are measured, flow proceeds to decision operation 406 where it is determined, while the web application is running in real-time, whether to adjust a behavior of the web application based on the plurality of performance characteristics. In one example, the plurality of performance characteristics may include script execution performance, network speed, server code execution performance, and network bandwidth. In this regard, when one or more of the plurality of performance characteristics indicates that adjusting and/or changing the behavior of the web application may optimize the web application performance, it may be determined to adjust the behavior of the web application. When it is determined not to adjust the behavior of the web application using the collected telemetry, flow proceeds back to operation 402 where telemetry is collected for the client computing device, the server computing device, and the network.

When it is determined to adjust the behavior of the web application based on the plurality of performance characteristics, flow proceeds to operation 408 where one or more web application characteristics are changed, while the web application is running in real-time, based on the plurality of performance characteristics. In one example, changing one or more web application characteristics may include at least one of batching network requests, using low resolution files, using high resolution files, using image sprites, using at least one alternate server API (Application Programming Interface), connecting to an alternate server, requesting resources from a plurality of servers, and limiting client operations. In some examples, changing one or more web application characteristics may be based on the performance characteristics of a combination of and/or all of the client computing device, the server computing device, and the network. That is, data corresponding to the performance characteristics of all three of the client computing device, the server computing device, and the network may be used to determine how to change one or more web application characteristics such that the web application performance is optimized.

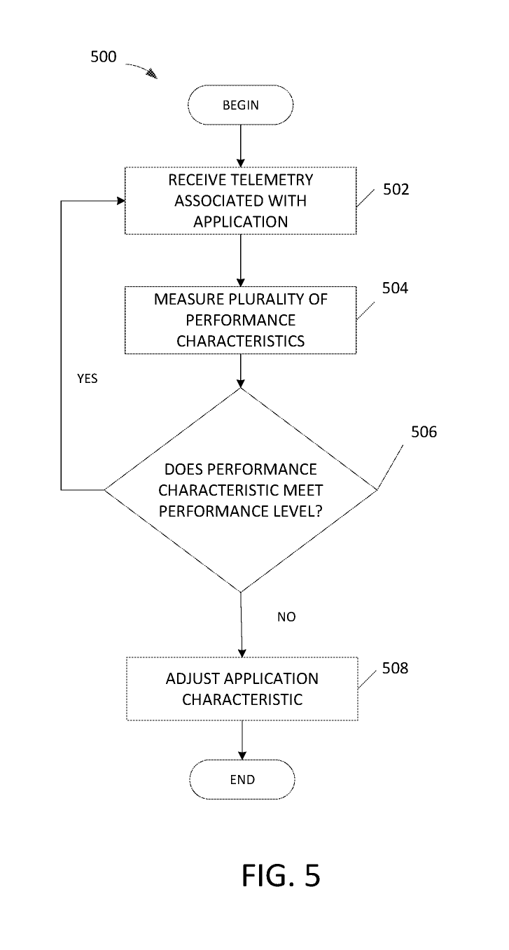

Referring now to FIG. 5, an exemplary method 500 for optimizing an application in real-time using telemetry, according to an example aspect is shown. Method 500 may be implemented on a computing device or a similar electronic device capable of executing instructions through at least one processor. Method 500 begins at operation 502 where telemetry for a client computing device, a server computing device, and a network associated with an application is received. For example, the received telemetry may provide information regarding performance characteristics of the client computing device, the server computing device and the network. In one example, telemetry for the client computing device is received at a client computing device. In another example, telemetry for the server computing device is received at a server computing device. In another example, telemetry for the network may be received by at least one of a client computing device and a server computing device. In another example, telemetry for the client computing device is received at a server computing device. In another example, telemetry for the server computing device is received at a client computing device.

When telemetry is received for a client computing device, a server computing device, and a network, flow proceeds to operation 504 where a plurality of performance characteristics of the client computing device, the server computing device, and the network are measured. In one example, the plurality of performance characteristics of the client computing device, the server computing device, and the network are measured by processing the collected telemetry. In one example, the plurality of performance characteristics may include script execution performance, network speed, server code execution performance, and network bandwidth. The script execution performance may indicate an amount of time it takes for various client computing device operations to be executed. The network speed may indicate an amount of time it takes for client requests and server responses to be communicated over the network. The server code execution performance may indicate an amount of time for the server computing device to process a request (e.g., the amount of time from when the server computing device receives the request and sends a response). The network bandwidth may indicate the performance of file downloads of varying sizes and/or how many files are requested at a given time.

When a plurality of performance characteristics of the client computing device, the server computing device, and the network are measured, flow proceeds to decision operation 506 where it is determined whether at least one performance characteristic of the plurality of performance characteristics meets a performance level. The performance level may provide an indication of how optimal the client computing device, the server computing device, and/or the network are performing functions and/or tasks. For example, the performance level of the client computing device when the client computing device is executing a script may be a particular amount of time. That is, the client computing device may be expected to execute a script in a number of seconds. When the client computing device executes the script in the expected number of seconds, the performance characteristic (e.g., script execution) meets the performance level. When the client computing device does not execute the script in the expected number of seconds, the performance characteristic (e.g., script execution) does not meet the performance level. In some examples, the performance level is different for each performance characteristic of the plurality of performance characteristics. For example, the performance level of the script execution performance characteristic may be an amount of time that it takes to execute a script. In another example, the performance level of the server code execution performance characteristic may be an amount of time that it takes for the server computing device to send a response when a request is received from the client computing device. In another example, the performance level of the network speed performance characteristic may be an amount of time that it takes to communicate requests and responses between the client computing device and the server computing device. When it is determined that the plurality of performance characteristics meet the performance level, flow proceeds back to operation 502 where telemetry for a client computing device, a server computing device, and a network associated with an application is received.

When it is determined that at least one performance characteristic of the plurality of performance characteristics does not meet the performance level, flow proceeds to operation 508 where at least one application characteristic is adjusted while the application is running in real-time. In one example, adjusting at least one application characteristic may include at least one of batching network requests, using low resolution files, using high resolution files, using image sprites, using at least one alternate server API (Application Programming Interface), connecting to an alternate server, requesting resources from a plurality of servers, and limiting client operations. In some examples, adjusting at least one application characteristic may be based on the performance characteristics of a combination of and/or all of the client computing device, the server computing device, and the network. That is, data corresponding to the performance characteristics of all three of the client computing device, the server computing device, and the network may be used to determine how to adjust the at least one application characteristic such that the application performance is optimized.

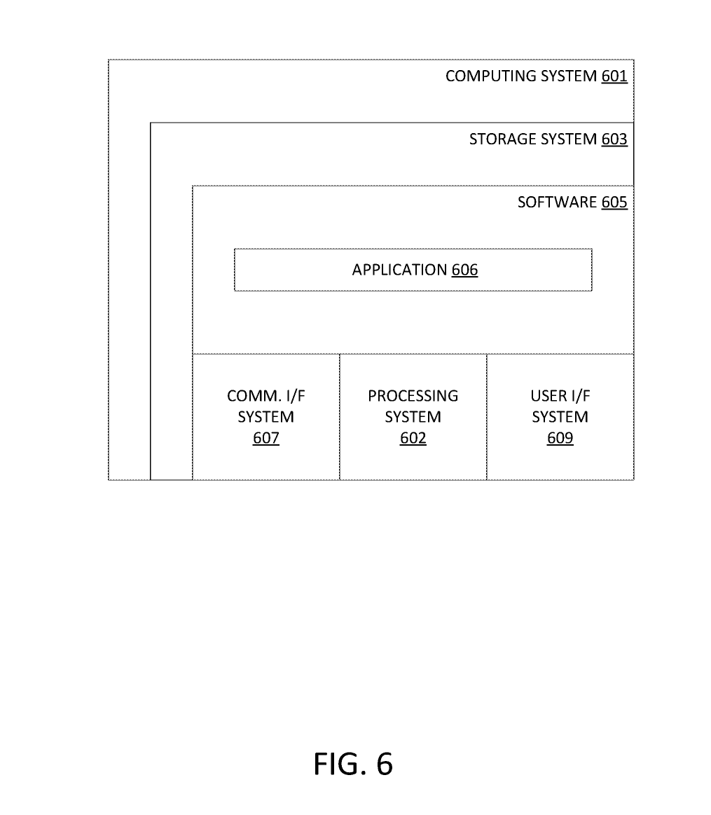

FIG. 6 illustrates computing system 601 that is representative of any system or collection of systems in which the various applications, services, scenarios, and processes disclosed herein may be implemented. Examples of computing system 601 include, but are not limited to, server computers, rack servers, web servers, cloud computing platforms, and data center equipment, as well as any other type of physical or virtual server machine, container, and any variation or combination thereof. Other examples may include smart phones, laptop computers, tablet computers, desktop computers, hybrid computers, gaming machines, virtual reality devices, smart televisions, smart watches and other wearable devices, as well as any variation or combination thereof.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609. Processing system 602 is operatively coupled with storage system 603, communication interface system 607, and user interface system 609.

Processing system 602 loads and executes software 605 from storage system 603. Software 605 includes application 606, which is representative of the applications and/or web applications discussed with respect to the preceding FIGS. 1-5. When executed by processing system 602 to enhance web application optimization, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device, but may also be distributed across multiple processing devices or sub-systems that cooperate in executing program instructions. Examples of processing system 602 include general purpose central processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device, but may also be implemented across multiple storage devices or sub-systems co-located or distributed relative to each other. Storage system 603 may comprise additional elements, such as a controller, capable of communicating with processing system 602 or possibly other systems.

Software 605 may be implemented in program instructions and among other functions may, when executed by processing system 602, direct processing system 602 to operate as described with respect to the various operational scenarios, sequences, and processes illustrated herein. For example, software 605 may include program instructions for implementing enhanced application optimization systems.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtual machine software, or other application software, in addition to or that include native mobile application 606. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to facilitate enhanced application optimization systems. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

User interface system 609 is optional and may include a keyboard, a mouse, a voice input device, a touch input device for receiving a touch gesture from a user, a motion input device for detecting non-touch gestures and other motions by a user, and other comparable input devices and associated processing elements capable of receiving user input from a user. Output devices such as a display, speakers, haptic devices, and other types of output devices may also be included in user interface system 609. In some cases, the input and output devices may be combined in a single device, such as a display capable of displaying images and receiving touch gestures. The aforementioned user input and output devices are well known in the art and need not be discussed at length here.

User interface system 609 may also include associated user interface software executable by processing system 602 in support of the various user input and output devices discussed above. Separately or in conjunction with each other and other hardware and software elements, the user interface software and user interface devices may support a graphical user interface, a natural user interface, or any other type of user interface.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses, computing backplanes, or any other type of network, combination of network, or variation thereof. The aforementioned communication networks and protocols are well known and need not be discussed at length here. However, some communication protocols that may be used include, but are not limited to, the Internet protocol (IP, IPv4, IPv6, etc.), the transfer control protocol (TCP), and the user datagram protocol (UDP), as well as any other suitable communication protocol, variation, or combination thereof.

In any of the aforementioned examples in which data, content, or any other type of information is exchanged, the exchange of information may occur in accordance with any of a variety of protocols, including FTP (file transfer protocol), HTTP (hypertext transfer protocol), REST (representational state transfer), WebSocket, DOM (Document Object Model), HTML (hypertext markup language), CSS (cascading style sheets), HTML5, XML (extensible markup language), JavaScript, JSON (JavaScript Object Notation), and AJAX (Asynchronous JavaScript and XML), as well as any other suitable protocol, variation, or combination thereof.

Among other examples, the present disclosure presents systems comprising: at least one processor; and memory encoding computer executable instructions that, when executed by the at least one processor, perform a method for adjusting a behavior of an application in real-time, the method comprising: receiving telemetry for a client computing device, a server computing device, and a network associated with the application; determining, while the application is running in real-time, whether to adjust the behavior of the application using the received telemetry; and in response to determining to adjust the behavior of the application, adjusting, while the application is running in real-time, the behavior of the application based on the received telemetry. In further examples, the behavior of the application is adjusted for a given user session. In further examples, adjusting, while the application is running in real-time, the behavior of the application based on the received telemetry comprises changing at least one application characteristic. In further examples, adjusting, while the application is running in real-time, the behavior of the application based on the received telemetry comprises changing a plurality of application characteristics. In further examples, the application is a web application. In further examples, determining, while the application is running in real-time, whether to adjust the behavior of the application using the received telemetry comprises processing the received telemetry to measure a plurality of performance characteristics of at least the client computing device, the server computing device, and the network. In further examples, the plurality of performance characteristics includes at least one of a network speed, a server code execution, a script execution, and network bandwidth. In further examples, changing at least one application characteristic comprises at least one of batching network requests, using low resolution files, using high resolution files, using image sprites, using at least one alternate server API (Application Programming Interface), connecting to an alternate server, requesting resources from a plurality of servers, and limiting client operations.

Further aspects disclosed herein provide an exemplary method for optimizing an application in real-time using telemetry, the method comprising: collecting telemetry for a client computing device, a server computing device, and a network associated with a web application; measuring a plurality of performance characteristics of the client computing device, the server computing device, and the network by processing the telemetry; determining, while the application is running in real-time, whether to adjust a behavior of the web application based on the plurality of performance characteristics; and in response to determining to adjust the behavior of the application, changing, while the web application is running in real-time, one or more web application characteristics based on the plurality of performance characteristics. In further examples, the one or more application characteristics are changed for a given user session. In further examples, the plurality of performance characteristics includes at least one of a network speed, a server code execution, a script execution, and network bandwidth. In further examples, changing, while the web application is running in real-time, the one or more web application characteristics based on the plurality of performance characteristics comprises batching network requests. In further examples, changing, while the web application is running in real-time, the one or more web application characteristics based on the plurality of performance characteristics comprises using at least one of a low resolution file and a high resolution file. In further examples, changing, while the web application is running in real-time, the one or more web application characteristics based on the plurality of performance characteristics comprises using image sprites. In further examples, changing, while the web application is running in real-time, the one or more web application characteristics based on the plurality of performance characteristics comprises using at least one alternate server API (Application Programming Interface). In further examples, changing, while the web application is running in real-time, the one or more web application characteristics based on the plurality of performance characteristics comprises connecting to an alternate server. In further examples, changing, while the web application is running in real-time, the one or more web application characteristics based on the plurality of performance characteristics comprises requesting resources from a plurality of servers. In further examples, changing, while the web application is running in real-time, the one or more web application characteristics based on the plurality of performance characteristics comprises limiting client operations.

Additional aspects disclosed herein provide exemplary systems comprising: one or more computer readable storage media; and program instructions stored on the one or more computer readable storage media that, when executed by at least one processor, cause the at least one processor to at least: receive telemetry for at least one of a client computing device, a server computing device, and a network associated with the application; measure a plurality of performance characteristics of at least one of the client computing device, server computing device, and network by processing the telemetry; when at least one performance characteristic of the plurality of performance characteristics does not meet a performance level, adjust, while the application is running in real-time, at least one application characteristic. In further examples, the performance level is different for each performance characteristic of the plurality of performance characteristics.

Techniques for optimizing an application in real-time using telemetry are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of optimized application systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
at least one processor; and
memory encoding computer executable instructions that, when executed by the at least one processor, perform a method for adjusting a behavior of an application in real-time, the method comprising:
receiving telemetry for a client computing device, a server computing device, and a network associated with the application;
determining, while the application is running in real-time, whether to adjust the behavior of the application using the received telemetry; and
in response to determining to adjust the behavior of the application, adjusting, while the application is running in real-time, the behavior of the application based on the received telemetry.

2. The system of claim 1, wherein the behavior of the application is adjusted for a given user session.

3. The system of claim 1, wherein adjusting, while the application is running in real-time, the behavior of the application based on the received telemetry comprises changing at least one application characteristic.

4. The system of claim 1, wherein adjusting, while the application is running in real-time, the behavior of the application based on the received telemetry comprises changing a plurality of application characteristics.

5. The system of claim 1, wherein the application is a web application.

6. The system of claim 1, wherein determining, while the application is running in real-time, whether to adjust the behavior of the application using the received telemetry comprises processing the received telemetry to measure a plurality of performance characteristics of at least the client computing device, the server computing device, and the network.

7. The system of claim 6, wherein the plurality of performance characteristics includes at least one of a network speed, a server code execution, a script execution, and network bandwidth.

8. The system of claim 3, wherein changing at least one application characteristic comprises at least one of batching network requests, using low resolution files, using high resolution files, using image sprites, using at least one alternate server API (Application Programming Interface), connecting to an alternate server, requesting resources from a plurality of servers, and limiting client operations.

9. A computer-implemented method for optimizing an application in real-time using telemetry, the method comprising:
collecting telemetry for a client computing device, a server computing device, and a network associated with a web application;
measuring a plurality of performance characteristics of the client computing device, the server computing device, and the network by processing the telemetry;
determining, while the application is running in real-time, whether to adjust a behavior of the web application based on the plurality of performance characteristics; and
in response to determining to adjust the behavior of the application, changing, while the web application is running in real-time, one or more web application characteristics based on the plurality of performance characteristics.

10. The computer-implemented method of claim 9, wherein the one or more application characteristics are changed for a given user session.

11. The computer-implemented method of claim 9, wherein the plurality of performance characteristics includes at least one of a network speed, a server code execution, a script execution, and network bandwidth.

12. The computer-implemented method of claim 9, wherein changing, while the web application is running in real-time, the one or more web application characteristics based on the plurality of performance characteristics comprises batching network requests.

13. The computer-implemented method of claim 9, wherein changing, while the web application is running in real-time, the one or more web application characteristics based on the plurality of performance characteristics comprises using at least one of a low resolution file and a high resolution file.

14. The computer-implemented method of claim 9, wherein changing, while the web application is running in real-time, the one or more web application characteristics based on the plurality of performance characteristics comprises using image sprites.

15. The computer-implemented method of claim 9, wherein changing, while the web application is running in real-time, the one or more web application characteristics based on the plurality of performance characteristics comprises using at least one alternate server API (Application Programming Interface).

16. The computer-implemented method of claim 9, wherein changing, while the web application is running in real-time, the one or more web application characteristics based on the plurality of performance characteristics comprises connecting to an alternate server.

17. The computer-implemented method of claim 9, wherein changing, while the web application is running in real-time, the one or more web application characteristics based on the plurality of performance characteristics comprises requesting resources from a plurality of servers.

18. The computer-implemented method of claim 9, wherein changing, while the web application is running in real-time, the one or more web application characteristics based on the plurality of performance characteristics comprises limiting client operations.

19. A system comprising:
one or more computer readable storage media; and
program instructions stored on the one or more computer readable storage media that, when executed by at least one processor, cause the at least one processor to at least:
receive telemetry for at least one of a client computing device, a server computing device, and a network associated with the application;
measure a plurality of performance characteristics of at least one of the client computing device, server computing device, and network by processing the telemetry;
when at least one performance characteristic of the plurality of performance characteristics does not meet a performance level, adjust, while the application is running in real-time, at least one application characteristic.

20. The system of claim 19, wherein the performance level is different for each performance characteristic of the plurality of performance characteristics.
